(19) United States
(12) Patent Application Publication
(10) Pub. No.: US 2006/0003138 A1
(43) Pub. Date: Jan. 5, 2006

(54) Film laminate with at least one diffusion-barrier layer and its use in vacuum insulation panels

(75) Inventors: Dirk Kaczmarek, Achim (DE); Sven Jacobsen, Bad Fallingbostel (DE)

Correspondence Address: FOLEY AND LARDNER LLP;SUITE 500, 3000 K STREET NW, WASHINGTON, DC, 20007, US

(73) Assignee: WIPAK WALSRODE GmbH CO. & KG

(21) Appl. No.: 11/152,851

(22) Filed: Jun. 15, 2005

(30) Foreign Application Priority Data
Jun. 16, 2004 (DE) 10 2004 028 839.9

(51) Int. Cl. B32B 27/06; B65D 1/00; B32B 27/36; B32B 27/32

(52) U.S. Cl. 428/69; 428/480; 428/500; 428/523; 428/349; 428/355 EN; 156/244.11

(57) ABSTRACT

At least one surface of the film laminate with at least one diffusion-barrier layer for production of a vacuum insulation panel has a heat-sealable layer, which comprises at least one sublayer of an additional diffusion-barrier layer composed of polyvinyl alcohol, in particular ethylene-vinyl alcohol copolymer (EVOH) within a multi-layer, preferably jointly extruded composite of the sealable-layer sublayers. The level of gas- and water-vapor-barrier effect provided by the high-barrier laminate can be significantly further increased, by a factor of about 2, by virtue of the additional diffusion-barrier layer integrated into the sealable layer.

### CROSS-REFERENCE TO RELATED PATENT APPLICATIONS

The right of foreign priority is claimed under 35 U.S.C. § 119(a) based on Federal Republic of Germany application Ser. No. 10/2004 028 839.9, filed Jun. 16, 2004, the entire contents of which, including the specification, drawings, claims and abstract, are incorporated herein by reference.

### BACKGROUND OF THE INVENTION

The invention relates to a film laminate with at least one diffusion-barrier layer for production of a vacuum insulation panel which is extremely impermeable to gas and to vapors.

Film laminates with diffusion-barrier layers or film composites with diffusion-barrier layers are used for various purposes. “High-barrier” films with particularly high resistance to gas diffusion are needed, inter alia, for production of vacuum insulation panels.

Vacuum insulation panels are sheets in which insulating materials or inert fillers are completely encapsulated within an envelope, and the envelope, which has maximum impermeability to gases, is very substantially evacuated. Very low gas diffusion values are needed for the envelope material so that once the vacuum has been applied, it is retained for the maximum time (at least from 10 to 15 years being desirable).

The extent of the vacuum depends on the insulating material used or the filler used and on the insulation effect expected from the panel. The expected level of impermeability of the envelope to gases is likewise dependent on the intended use. In the case of vacuum insulation panels (VIPs) intended for use in consumer goods which do not have very great lifetimes, e.g., camping refrigerators, cooler boxes and the like, the requirements are less stringent than for a panel intended for the construction sector and requiring maximum retention of the vacuum in order not to require replacement during the lifetime of a house.

Initially, aluminum foils were used for the envelope material of VIPs having very high impermeability to gases. However, a disadvantage of the metallic envelope was that there were heat bridges at the panel edges, and these reduced total insulation effect.

Nowadays, vacuum insulation panels (VIPs) use what are known as high-barrier films, these often being film laminates having from 3 to 5 layers, of which individual layers, mainly internal layers, have generally been metallized, i.e., have a vapor-deposited coating of a metal, such as aluminum, or have been provided with a highly gas-impermeable coating composed of, for example, silicon oxide (SiOx) or of metal oxides of the 2nd or 3rd main group of the Periodic Table. The main metal oxides which can be used for a (vapor-deposited) coating are magnesium oxide, aluminum oxide, calcium oxide, and beryllium oxide.

By way of example, DE 100 25 305 A1 (=U.S. 2001/0049014) or DE 100 47 043 A1 (=U.S. Pat. No. 6,740,394) disclose film laminates with a high level of gas-barrier effect. The high-barrier layers described there are sufficient to provide a very good barrier effect, but that effect should be still further improved.

### SUMMARY OF THE INVENTION

The invention is therefore based on the object of designing a high-barrier film in such a way as to give a further rise in the level of barrier effect.

The object is achieved via a film laminate which has at least one diffusion-barrier layer and at least one surface of which has a heat-sealable layer which comprises at least one sublayer of an additional diffusion-barrier layer within a multilayer composite.

### DETAILED DESCRIPTION OF THE PREFERRED EMBODIMENTS

The inventive film laminate can be used for production of vacuum insulation panels with an extremely high level of barrier effect for a very wide variety of applications.

There are no particular restrictions on the nature of the sealable layer. Use may be made of any of the heat-sealable layers which are suitable and known to those skilled in the art for the purpose of hot-sealing, preferably made of synthetic resin. A heat-sealable polyolefin layer is currently preferred, in particular a heat-sealable polyethylene layer. Use may generally be made of polyolefin homo- or copolymers. Preference is given to linear low-density polyethylene (LLDPE), polybutylene (PB), ethylene-vinyl acetate (EVA), polypropylene (PP), high-density polyethylene (HDPE), ionomers (IO) and mixtures of these substances. The thickness of the sealable layers used in the invention is from 20 to 100 μm, preferably from 30 to 60 μm.

The invention provides that the sealable layer or two or more sealable layers have been equipped with an additional barrier layer in order to provide a still further increase in the barrier effect of the laminate. The additional barrier layer integrated into the sealable layer may comprise a layer composed of polyvinyl alcohol, in particular composed of ethylene-vinyl alcohol copolymer (EVOH), polyethylene terephthalate (PET), or a mixture thereof; the integrated barrier layer moreover preferably comprises at least one of the abovementioned constituents.

One possible layer structure for this “sealable layer with barrier layer” (PEX) would be:
PE/AP/barrier/AP/PE
Key: barrier=EVOH or PET, AP=adhesion promoter and
PE=heat-sealable polyethylene layer.

The barrier layer is preferably generally linked to the polyolefin layer, in the example a polyethylene layer, by way of a customary adhesion promoter familiar for this purpose to the person skilled in the art. The integrated sealable-and-barrier layer (PEX) may preferably be produced via co-extrusion of the individual layers.

Exemplary film laminates according to the invention equipped with an additional barrier layer in the sealable layer are given in the examples.

Use of the sealable layer with barrier function (PEX) within the inventive film laminate can further increase the barrier effect, i.e., impermeability to gases and to vapors.

If a further metallized film were to be applied by lamination, instead of the EVOH in the sealable layer, no significant increase in the barrier would occur because in each lamination step the film experiences additional mechanical and thermal stress, the result being no additional increase in the level of barrier action. The known films cannot therefore be substantially improved via addition of further, conventional diffusion-barrier layers.

Surprisingly, however, it has been found that an additional, preferably co-extruded diffusion-barrier layer within at least one of the external sealable layers can increase the level of gas-barrier effect by a factor of up to about 2 (the variables generally measured being permeability to water vapor and oxygen).

The additional diffusion-barrier layer is preferably incorporated at least into that layer which is subsequently external during use of the film. The result is to increase the gas-permeability barrier at an early (upstream) stage ahead of the first layer, so that less gas can penetrate into the interior of the film from which it can diffuse further.

The thickness of the diffusion-barrier layer additionally integrated into at least one of the sealable layers is preferably from 0.5 to 10 μm, more preferably <5 μm, the total thickness of the sealable layer being from 20 to 100 μm.

The diffusion-barrier layers used within the high-barrier film laminate of the invention (apart from the sealable layers) may comprise any of the layer combinations and layers customary for this purpose. Suitable layer combinations are found, inter alia, in DE 100 25 305 A1 (=U.S. 2001/0049014) or DE 100 47 043 A1 (=U.S. Pat. No. 6,740,394), the entire disclosures of which are hereby incorporated by reference. Preference is given to films composed of polyester, of polyamide, or of polypropylene and coated on one side or on both sides, and this coating is generally a vapor-deposited coating. The diffusion-inhibiting (vapor-deposited) coatings used are mainly metallization, preferably with aluminum, or coatings composed of silicon oxide (SiOx), or of a metal oxide of the 2nd or 3rd main group. The customary thickness of metallized films composed of polyester or of polyamide is, by way of example, around 12 μm and that of metallized polypropylene films is around 18 μm.

The high-barrier films or film laminates comprising diffusion-barrier layers encompass individual films and/or co-extruded composite films bonded together via lamination. The film composite may also comprise co-extruded layers which have undergone a vapor-deposition process and which themselves comprise at least one sublayer of a gas-diffusion-barrier layer, preferably composed of polyvinyl alcohol, in particular composed of ethylene-vinyl alcohol copolymer (EVOH). The vapor-deposition thickness of the diffusion-barrier layers is preferably from 30 to 100 nm.

One preferred embodiment provides that at least one flame retardant has also been added to the film laminate, at least in the outermost sealable-layer sublayer, the amount of the flame retardant preferably being from 0.1 to 30% by weight, based on the weight of the respective sealable-layer sublayer to which the agent has been added. As an alternative, the outer surface of at least one sealable layer of the laminate may have been treated with a flame retardant, preferably applied from solution.

By way of example, the flame retardant used may comprise antimony trioxide (SbO₃) alone or in combination with an organohalogen flame retardant, but preferably an organobromine flame retardant. The flame retardant may be present with uniform fine dispersion in the sealable layer and may have been introduced in any suitable manner into the sealable layer, e.g., during or after the polymerization process in the form of an additive, dispersed in powder form or in solution, or in the form of “incorporated” reactive flame retardant during the polymerization process.

The flame retardant may also be present within only one layer of a co-extruded composite of a sealable film. This type of single- or multilayer sealable polyolefin film equipped with a flame retardant may then have been bonded via lamination to one or more diffusion-barrier layers, e.g., metallized films.

It is also possible to use two or more flame retardants in combination, in which case, in order to ensure that the sealable layer is functional, the total amount should preferably not be greater than 50% by weight, more preferably not greater than 30% by weight, based on the polyolefin composition. The amount of the flame retardant needed for effectiveness and to comply with fire-protection requirements can be determined experimentally by the person skilled in the art; in each case, the values depend on the nature of the flame retardant. The amount preferably present in the film composite, based on the polyolefin composition in which the flame retardant has been dispersed, is from 0.1 to 30% by weight, more preferably from 0.1 to 10% by weight, more preferably below 5% by weight, more preferably from 1 to 3% by weight.

As an alternative, the flame retardants or the mixtures thereof may also be applied from solution to the surface of the sealable layer. The ratio between the weight of the coating and the weight of the sealable layer in percent by weight should likewise be as stated above.

If the production of the panel is to use a high-barrier film which is sealable on both sides, the fire retardant or flame retardant may be present in or on both external sealable layers. If the fire retardant is introduced only on one side, that side should be identified as the outside, for example via printing or coloring.

The invention also encompasses the use of or the process of using the film laminates described in more detail above for production of a vacuum insulation panel, and a vacuum insulation panel thus produced, in which an inert filler or an insulating material has been enclosed by a substantially gas-tight envelope composed of a film laminate of the invention. The shape of the panel is preferably that of a sheet, which has been cut out of the insulating material or has been compression molded from a pulverulent filler. The sheet is enclosed by the inventive film laminate in such a way as to provide the additional diffusion-barrier layer at least in or on the outer layer, which is a heat-sealable layer and is furthest from the insulating material.

### EXAMPLES

The following exemplary layer structures for film laminates of the invention are given without restricting the general applicability of the invention:

### Inventive Example 1

PM/MPP/MP/PEX; single-side-sealable film laminate; layer thicknesses (in μm): 12/18/12/50

### Inventive Example 2

PEX/PPM/MPP/MPP/PEX; thickness (in μm): 50/18/18/18/50; PEX comprises PE with EVOH

Water-vapor permeability=WVP (38° C., 90% rel. hum.)<0.03 g/m²·d, O₂ permeability=O₂P: <0.01 cm³/m²·d·bar (23° C., 75% rel. hum.)

PEX=PE/AP/EVOH/AP/PE;

PM or MP=metallized polyester film (the sequence of the letters indicates the position of the metallization in the layer structure)

PPM or MPP=metallized polypropylene film (the sequence of the letters indicates the position of the metallization in the layer structure)

/=layer sequence, position of lamination between layers

The abovementioned layer structures are merely non-restricting examples and, by way of example, it is also possible, as described in DE 100 47 043, for another barrier layer composed of polyvinyl alcohol, ethylene-vinyl alcohol copolymer, or polyethylene to be present in the interior of the layer structure.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

Water-vapor permeability and oxygen-permeability studies

| | | | | | | | | |
|---|---|---|---|---|---|---|---|---|
| | Conditions | Conditions | | | | | [g/m²d] | |
| Film No. | °C. | % rel. hum. | Measurement | [g/m²d] | [g/m²d] | [g/m²d] | Average | Comment |

| | | | | | | | | |
|---|---|---|---|---|---|---|---|---|
| Inventive | 38 | 90 | WVP | 0.01 | 0.02 | 0.03 | 0.02 | after 6 |
| example 2 | | | | | | | | days |
| Comparison | 38 | 90 | WVP | 0.04 | 0.04 | 0.04 | 0.04 | |

| | | | | | | | [cm³/m² · d · bar] | |
|---|---|---|---|---|---|---|---|---|
| | | | | [cm³/m² · d · bar] | [cm³/m² · d · bar] | [cm³/m² · d · bar] | average | |
| Inventive | 23 | 75 | O₂P | 0.01 | 0.01 | | 0.01 | after 6 |
| example 2 | | | | | | | | days |
| Comparison | 23 | 75 | O₂P | <0.01 | | | <0.01 | |

Comparison: PE film of corresponding constitution and thickness without diffusion-barrier layer

What is claimed is:

1. A film laminate suitable for production of a vacuum insulation panel, the laminate comprising:
at least a first diffusion-barrier layer; and a heat-sealable layer on at least one surface of the film laminate, the heat-sealable layer comprising a multi-layer composite having at least one sublayer comprised of at least one second diffusion-barrier layer.

2. The film laminate as claimed in claim 1, wherein the second diffusion-barrier layer comprises a polymer selected from the group consisting of polyvinyl alcohol, ethylene-vinyl alcohol copolymer (EVOH), polyethylene terephthalate (PET), and a mixture thereof.

3. The film laminate as claimed in claim 1, wherein the sealable layer comprises a heat-sealable polyolefin layer

4. The film laminate as claimed in claim 3, wherein the sealable layer comprises a heat-sealable polyethylene layer.

5. The film laminate as claimed in claim 4, wherein the sealable layer is on both sides of the film laminate.

6. The film laminate as claimed in claim 1, wherein the thickness of the second diffusion-barrier layer is from 0.5 to 10 μm, the total thickness of the sealable layer being from 20 to 100 μm.

7. The film laminate as claimed in claim 6, wherein the thickness of the second diffusion-barrier layer is <5 μm.

8. The film laminate as claimed in claim 1, wherein the first diffusion polypropylene film, a polyamide film and a polyester film wherein the polymer film is metallized or has been subjected to a vapor-deposition process using SiOx or using a metal oxide of the 2nd or 3rd main group of the Periodic Table.

9. The film laminate as claimed in claim 1, which is comprised of individual layers that have been bonded via lamination.

10. The film laminate as claimed in claim 1, wherein at least the multi-layer composite comprises a co-extruded composite layer.

11. The film laminate as claimed in claim 1, wherein the first diffusion-barrier layers comprise layers which have been subjected to vapor deposition on one or both sides.

12. The film laminate as claimed in claim 1, wherein the at least one heat-sealable layer includes at least one flame retardant, the amount of flame retardant being from 0.1 to 30% by weight, based on the weight of the respective sealable-layer sublayer to which the agent has been added.

13. The film laminate as claimed in claim 1, wherein the outer surface of at least one heat-sealable layer of the laminate has been treated with a flame retardant which has been applied from solution.

14. The film laminate as claimed in claim 12, wherein the flame retardant comprises antimony trioxide and/or an organohalogen flame retardant.

15. The film laminate as claimed in claim 14, wherein the flame retardant comprises an organobromine flame retardant.

16. The film laminate as claimed in claim 13, wherein the flame retardant comprises antimony trioxide and/or an organohalogen flame retardant.

17. The film laminate as claimed in claim 16, wherein the flame retardant comprises an organobromine flame retardant.

18. The film laminate as claimed in claim 8, wherein the vapor-deposition thickness of the first diffusion-barrier layers is from 30 to 100 nm.

19. A vacuum insulation panel, comprising:
an inert filler completely enclosed by a substantially gas-tight envelope, wherein the enclosed space has been substantially evacuated of all gases, and wherein the gas-tight envelope comprises a film laminate as claimed in claim 1.

20. A method for making a film laminate, comprising:
providing a core layer comprising at least a first diffusion-barrier layer;
co-extruding a heat-sealable laminate having at least one sublayer comprised of at least one second diffusion-barrier layer; and
laminating the heat-sealable layer and the core layer together to produce the film laminate, such that the heat-sealable laminate forms a surface layer on at least one side of the film laminate.
